(19) United States
(12) Patent Application Publication
(10) Pub. No.: US 2009/0067386 A1
(43) Pub. Date: Mar. 12, 2009

(54) METHOD AND APPARATUS FOR CELL RESELECTION ENHANCEMENT FOR E-UTRAN

(75) Inventor: Masato Kitazoe, Tokyo (JP)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/141,785

(22) Filed: Jun. 18, 2008

Related U.S. Application Data
(60) Provisional application No. 60/945,068, filed on Jun. 19, 2007.

(51) Int. Cl. H04W 36/30

(52) U.S. Cl. 370/332

(57) ABSTRACT

A framework for the cell reselection and associated measurement behavior is proposed based on a state in which a UE is camped on the cell. If the UE is ‘camped in any cell state’, inter-frequency and/or inter-RAT measurements are prioritized over intra-frequency measurements. The proposed scheme helps the UE to find a suitable cell while in the camped on any cell state. If the UE subscribes to specific frequencies, separate measurement rules are implemented to aid the UE to find and camp on the preferred frequencies. The proposed scheme also considers access related information in addition to radio quality to help the UE in making cell selections thereby mitigating the UE from camping on restricted cells. Such aspects minimize situations wherein users are limited due to the service provided by an operator.

### CROSS-REFERENCE TO RELATED APPLICATION(S)

This application claims the benefit of U.S. Provisional Patent Application Ser. No. 60/945,068 filed on Jun. 19, 2007 and entitled “METHOD AND APPARATUS FOR CELL RESELECTION ENHANCEMENT FOR E-UTRAN”, the entirety of which is incorporated herein by reference.

### BACKGROUND OF THE INVENTION

Wireless communication systems are widely deployed to provide various types of communications such as voice, data, video, etc. These systems may be multiple-access systems capable of supporting communication with multiple access terminals by sharing available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems. Typically, a wireless communication system comprises several base stations, wherein each base station communicates with a mobile station using a forward link and each mobile station (or access terminal) communicates with base station(s) using a reverse link.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out (SISO), multiple-in-signal-out (MISO) or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels, where N_{S}≦min{N_{T}, N_{R}}. Each of the NS independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the eNode B to extract transmit beamforming gain on the forward link when multiple antennas are available at the eNode B.

The handover procedure is what makes a mobile station (MS) or UE mobile. It involves transferring an ongoing voice/data session from one eNB (Evolve Node B) to another. Successful handovers facilitate uninterrupted voice service to the user even while traveling across cell boundaries. Unsuccessful handovers are often the cause of dropped calls. Handovers involve cell transition procedures which are important in allowing the UE to change to neighboring cells when the quality and strength of the current cell's signal degrades beyond the UE's threshold. Hence, various rules to govern different situations wherein cells with different attributes are encountered by the UE during searching: need to be explored in order to improve service quality in wireless communication networks.

### SUMMARY OF THE INVENTION

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

An aspect relates to a method for providing service within a wireless communication system. The method facilitates determining a state in which a UE is camped on a cell and facilitating the UE to carry out one or more measurements for cell reselection based at least on the state of camping on the cell. In accordance with a further aspect, if the UE is camped on an acceptable cell in a ‘camped on any cell’ state which causes the UE to receive limited or no service, inter-frequency or inter-RAT (Radio Access Technology) measurements are prioritized over intra-frequency measurements. Additionally, the ‘camped on any cell’ state can be attributed as a situation in which the UE is camping on a cell on a frequency that is categorized as non-preferred according to e.g. network operator's policy. A most suitable cell is identified in at least one of the inter-frequency or inter-RAT measurements and the UE camps normally on it. If no cell is identified as the most suitable cell in the inter-frequency or inter-RAT measurements, one or more intra-frequency measurements are executed to find other cells within the serving frequency. In a further aspect, if UE subscribes to one or more preferred frequencies and is camped on a non-preferred frequency inter-frequency measurements are executed that identify if one or more of the preferred frequencies is available, to the UE to camp on normally.

Another aspect relates to reading access related information of one or more cells during the measurements for the cell reselection. If the measurements relate to inter-frequency measurements, access related information associated with a highest ranked cell for each frequency is obtained and the cells are prioritized into preferred and non-preferred categories based on the access related information or on the information provided separately.

Another aspect relates to applying an offset value to measured radio quality for those cells in the serving frequency being non-preferred category such that the UE is encouraged to move to at least a cell indentified in an inter-frequency or inter-RAT search. A further aspect relates to the UE indentifying an alternate cell using a cell reselection parameter when the UE is camped on a barred cell in a ‘camped on any cell’ state.

An apparatus for facilitating cell selection within a communication system is disclosed in accordance with another aspect. The apparatus comprises a processor that implements a measurement procedure for cell reselection for a UE based on a state in which the UE is currently camped on a cell. A memory component stores system information that determines the state in which the UE is currently camped. If the state is a ‘camped on any cell’ state, the processor prioritizes inter-frequency or inter-RAT searches over an intra-frequency search. A receiving component, also comprised within the apparatus, receives the system information comprising access restrictions associated with at least a cell. The processor reads and analyzes the access restrictions for ranking a plurality of cells during the measurement procedures for the UE to camp on. One or more offset values stored in the memory component are associated with cells that only permit the UE to camp in a camped on any cell state. These offset values are used in the ranking process to make inter-frequency or inter-RAT cells look better so that the UE is encouraged to move from the serving frequency.

Another aspect relates to a computer program product comprising a computer-readable medium comprising: code for causing at least a computer to determine a state in which a UE is camped on a cell; and code for causing at least a computer to facilitate the UE to carry out one or more measurements for cell reselection based at least on the state of camping on the cell. The code facilitates determining a state in which a UE is camped on a cell. Furthermore, the code facilitates the UE to carry out one or more measurements for cell reselection based at least on the state of camping on the cell. If the UE is camped on the cell in a camped on any cell state which causes the UE to receive limited or no service, the medium comprises instructions for prioritizing one or more of inter-frequency or inter-RAT (Radio Access Technology) measurements over one or more intra-frequency measurements.

A system for facilitating cell selection is disclosed in accordance with yet another aspect. It comprises means for implementing a measurement procedure for cell reselection for a UE based on a state in which the UE is currently camped on a cell and means for receiving system information that determines the state in which the UE is currently camped. If UE is in ‘camped on any cell’ state, the measurement procedure prioritizes one or more of inter-frequency or inter-RAT searches over an intra-frequency search.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become-apparent from the following detailed description of the claimed subject matter when considered in conjunction with the drawings.

### BRIEF DESCRIPTION OF THE DRAWINGS

FIG. 1 illustrates a multiple access wireless communication system according to one embodiment.

FIG. 2 is a block diagram of an embodiment of an eNode B and an access terminal (or a UE) in a MIMO system.

FIG. 3 is an illustration of a wireless multiple-access communication system in accordance with various aspects described herein.

FIG. 4 is a flow chart that details a methodology of cell search in accordance with an aspect.

FIG. 5A is a graphical depiction of the measurement rules for the UE in accordance with an aspect when the UE is in a camped normally state.

FIG. 5B is a graphical depiction of the measurement rules for the UE in accordance with an aspect when the UE is in a camped on any cell state.

FIG. 6 is a flow chart detailing the procedure of cell reselection in accordance with the measurement rules described herein when the UE is camped normally on a cell.

FIG. 7 is a flow chart that illustrates a method of cell searching in accordance with measurement rules when the UE is in a ‘camped on any cell’ mode.

FIG. 8A shows a flow chart that details another aspect related to adopting/ignoring measurement rules depending on the attributes a the UE and/or serving frequencies.

FIG. 8B is a flow chart related to another aspect wherein based on the attributes of the frequencies and the subscription plan associated with the UE different measurement rules can be adopted for the cell selection/reselection procedures.

FIG. 9 is a flow chart detailing a more efficient ranking mechanism in accordance with an aspect.

FIG. 10 depicts a flow chart that details the categorization of cells in accordance with an aspect.

FIG. 11 illustrates a high-level system diagram of various components of a device in accordance with various aspects.

FIG. 12 illustrates a block diagram of an example system that enables cell selection in accordance with aspects described herein.

### DESCRIPTION OF THE INVENTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Various embodiments are now described with reference to the drawings, wherein like reference numerals are used to refer to like elements throughout. In the following description, for purposes of explanation, numerous specific, details are set forth in order to provide a thorough understanding of one or more aspects. It may be evident however, that such embodiment(s) may be practiced without these specific details. In other instances, well-known structures and devices are shown in block diagram form in order to facilitate describing one or more embodiments. As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an integrated circuit, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Various embodiments will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The word “exemplary” is used herein to mean “serving as an example, instance, or illustration.” Any embodiment or design described herein as “exemplary” is not necessarily to be construed as preferred or advantageous over other embodiments or designs. The word “listening” is used herein to mean that a recipient device (eNode B or UE) is receiving and processing data received on a given channel.

Various aspects can incorporate inference schemes and/or techniques in connection with transitioning communication resources. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events, or decision theoretic, building upon probabilistic inference, and considering display actions of highest expected utility, in the context of uncertainty in user goals and intentions. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, various aspects are described herein in connection with a subscriber station. A subscriber station can also be called a system, a subscriber unit, mobile station, mobile, remote station, access point, eNode B, remote terminal, access terminal, user terminal, user agent, a user device, mobile device, portable communications device, or user equipment (UE). A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA: includes Wideband-CDMA (W-CDMA) and Low Chip Rate (LCR) cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

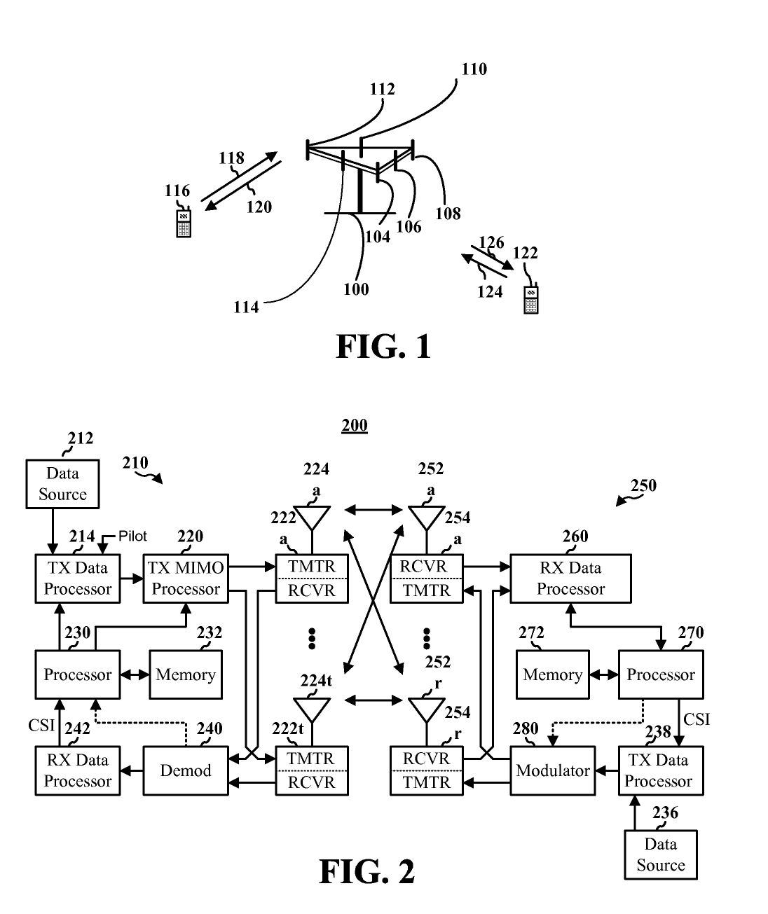

Referring to FIG. 1, a multiple access wireless communication system according to one embodiment is illustrated. An eNode B 100 includes multiple antenna groups, wherein a first group includes antennas 104 and 106, another includes 108 and 110, and an additional group includes 112 and 114. In FIG. 1, only two antennas are shown for each antenna group, however, more or fewer antennas may be utilized for each antenna group. UE (user equipment) or AT (access terminal) 116 is in communication with antennas 112 and 114, where antennas 112 and 114 transmit information to UE 116 over forward link 120 and receive information from UE 116 over reverse link 118. UE 122 is in communication with antennas 106 and 108, where antennas 106 and 108 transmit information to UE 122 over forward link 126 and receive information from UE 122 over reverse link 124. In a FDD system, communication links 118, 120, 124 and 126 may use different frequencies for communication. For example, forward link 120 may use a different frequency than that used by reverse link 118. Each group of antennas and/or the area in which they are designed to communicate is often referred to as a sector of the access point or eNode B. In the embodiment, antenna groups are each designed to communicate to UEs in a sector within the areas covered by eNode B 100.

In communication over forward links 120 and 126, the transmitting antennas of eNode B 100 utilize beamforming in order to improve the signal-to-noise ratio of forward links for the different UEs 116 and 124. Also, an eNode B using beamforming to transmit to UEs scattered randomly through its coverage area causes less interference to UEs in neighboring cells than an eNode B transmitting through a single antenna to all its UEs.

An eNode B may be a fixed station used for communicating with the terminals and may also be referred to as an access point, a Node B, an enhanced Node B (eNode B) or some other terminology. An access terminal (AT) may also be called a user equipment (UE), a wireless communication device, terminal, or some other terminology.

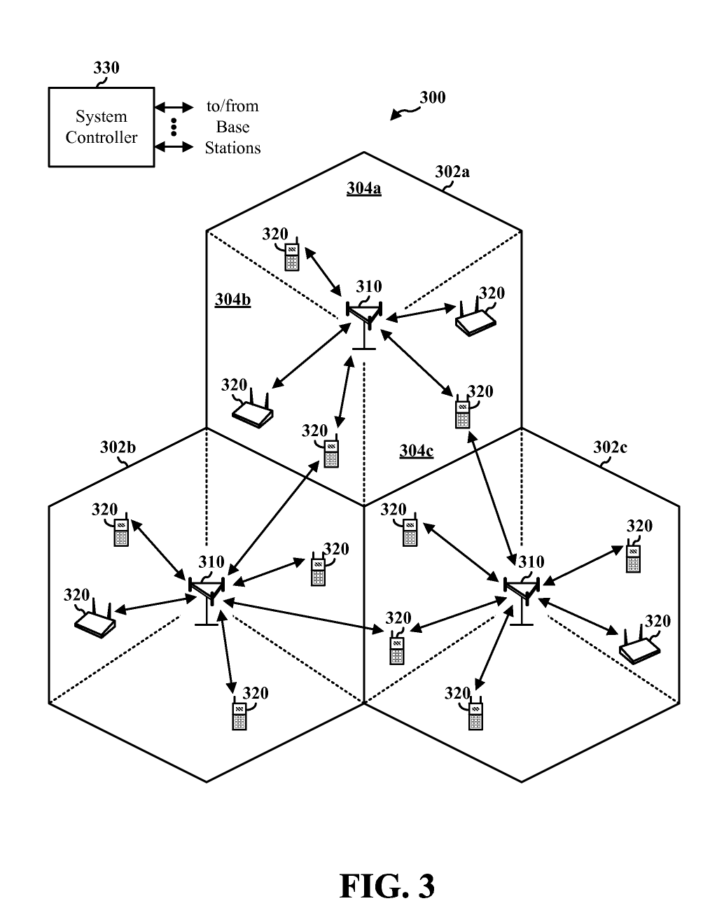

FIG. 2 is a block diagram of an embodiment of an eNode B 210 and a access terminal (AT) or user equipment (UE) 250 in a MIMO system 200. At the eNode B 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At the UE 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The received symbols or other information can be stored in an associated memory 272. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at the eNode B 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. Information received on the reverse link can be stored in an associated memory 232. The reverse link message is then processed by a TX data processor 238, which also receives traffic data for a number of data streams from a data source 236, modulated by a modulator 280, conditioned by transmitters 254a through 254r, and transmitted back to transmitter system 210.

At the eNode B 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several. MTCHs. Generally, after establishing RRC connection this channel is only used by UEs that receive MBMS. Dedicated Control Channel (DCCH) is Point-to-point bi-directional channel that transmits dedicated control information and used by UEs having an RRC connection. In aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Channel (DL-SCH) and a Paging Channel (PCH), the PCH for support of UE power saving (DRX cycle is indicated by the network to the UE), broadcasted over entire cell and mapped to PHY resources which can be used for other control/traffic channels. DL transport channel associated with MBMS is Multicast Channel (MCH) The UL Transport Channels comprises a Random Access Channel (RACH), Uplink Shared Data Channel (UL-SDCH) and plurality of PHY channels. The PHY channels comprises a set of DL channels and UL channels.

The DL PHY channels and signals comprises:

Reference signal (RS)

### Primary and Secondary Synchronization Signals (PSS/SSS)

### Physical Downlink Shared Channel (PDSCH)

### Physical Downlink Control Channel (PDCCH)

### Physical Multicast Channel (PMCH)

### Physical HARQ Indicator Channel (PHICH)

### Physical Control Format Indicator Channel (PCFICH)

The UL PHY Channels comprises:

### Physical Random Access Channel (PRACH)

### Physical Uplink Control Channel (PUCCH)

### Channel Quality Indicator (CQI)

### Precoding Matrix Indicator (PMI)

### Rank Indicator (RI)

Scheduling request (SR)

### Uplink ACK/NAK

### Physical Uplink Shared Channel (PUSCH)

### Sounding Reference Signal (SRS)

In an aspect, a channel structure is provided that preserves low PAR (at any given time, the channel is contiguous or uniformly spaced in frequency) properties of a single carrier waveform.

For the purposes of the present document, the following abbreviations apply:

### AM Acknowledged Mode

### AMD Acknowledged Mode Data

### ARQ Automatic Repeat Request

### BCCH Broadcast Control CHannel

### BCH Broadcast CHannel

### C—Control—

### CCCH Common Control CHannel

### CCH Control CHannel

### CCTRCH Coded Composite Transport Channel

### CP Cyclic Prefix

### CRC Cyclic Redundancy Check

### CTCH Common Traffic CHannel

### DCCH Dedicated Control CHannel

### DCH Dedicated CHannel

### DL DownLink

### DSCH Downlink Shared CHannel

### DTCH Dedicated Traffic CHannel

FACH Forward link Access CHannel

### FDD Frequency Division Duplex

L1 Layer 1 (physical layer)
L2 Layer 2 (data link layer)
L3 Layer 3 (network layer)

### LI Length Indicator

### LSB Least Significant Bit

### MAC Medium Access Control

### MBMS Multmedia Broadcast Multicast Service

MCCH MBMS point-to-multipoint Control CHannel

### MRW Move Receiving Window

### MSB Most Significant Bit

MSCH MBMS point-to-multipoint Scheduling CHannel
MTCH MBMS point-to-multipoint Traffic CHannel

### PCCH Paging Control CHannel

### PCH Paging CHannel

### PDU Protocol Data Unit

PHY PHYsical layer

### PhyCH Physical CHannels

### RACH Random Access CHannel

### RLC Radio Link Control

### RRC Radio Resource Control

### SAP Service Access Point

### SDU Service Data Unit

### SN Sequence Numnber

### SUFI SUper FIeld

### TCH Traffic CHannel

### TDD Time Division Duplex

### TFI Transport Format Indicator

### TM Transparent Mode

TMD Transparent. Mode Data

### TTI Transmission Time Interval

### U—User—

### UE User Equipment

### UL UpLink

### UM Unacknowledged Mode

### UMD Unacknowledged Mode Data

### UMTS Universal Mobile Telecommunications System

### UTRA UMTS Terrestrial Radio Access

### UTRAN UMTS Terrestrial Radio Access Network

MBSFN multicast broadcast single frequency network
MCE MBMS coordinating entity
MCH multicast channel
DL-SCH downlink shared channel
MSCH MBMS control channel
PDCCH physical downlink control channel
PDSCH physical downlink shared channel
MBSFN multicast broadcast single frequency network
MCE MBMS coordinating entity
MCH multicast channel
DL-SCH downlink shared channel
MSCH MBMS control channel
PDCCH physical downlink control channel
PDSCH physical downlink shared channel
PUCCH physical uplink control channel
PUSCH physical uplink shared channel

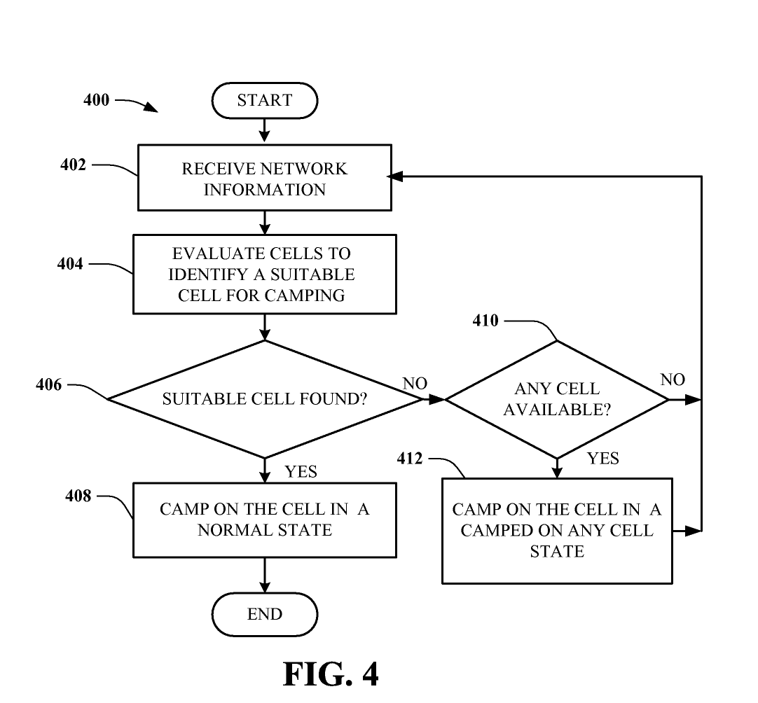

FIG. 3 is an illustration of a wireless multiple-access communication system 300 in accordance with various aspects. In one example, the wireless multiple-access communication system 300 includes multiple eNode Bs 310 and multiple UEs 320. Each eNode B 310 provides communication coverage for a particular geographic area 302 (e.g., 302a, 302b, 302c). The term “cell” can refer to an eNode B and/or its coverage area depending on the context in which the term is used. To improve system capacity, an access terminal coverage area may be partitioned into multiple smaller areas, e.g., three smaller areas 304a, 304b, and 304c. Each smaller area is served by a respective eNode B. The term “sector” can refer to an eNode B and/or its coverage area depending on the context in which the term is used. For a sectorized cell, the eNode Bs for all sectors of that cell are typically co-located within the base station for the cell. The signaling transmission techniques described herein may be used for a system with sectorized cells as well as a system with un-sectorized cells. For simplicity, in the following description, the term “base station” or eNode B is used generically for a station that serves a sector as well as a station that serves a cell.

Terminals or UEs 320 are typically dispersed throughout the system, and each UE may be fixed or mobile. A terminal may also be called, and may contain some or all of the functionality of, a mobile station, user equipment (UE), and/or some other device. A terminal may be a wireless device, a cellular phone, a personal digital assistant (PDA), a wireless modem card, and so on. A terminal may communicate with zero, one, or multiple base stations on the forward and reverse links at any given moment.

For a centralized architecture, a system controller 330 couples to APs 310 and provides coordination and control for these base stations. System controller 330 may be a single network entity or a collection of network entities. For a distributed architecture, the APs 310 may communicate with one another as needed.

One or more aspects of a wireless communication system design are described that support full & half duplex FDD (Frequency Division Duplex) and TDD (Time Division Duplex) modes of operation, with support for scalable bandwidth. However, this need not be the case, and other modes may also be supported in addition to, or in lieu, of the previous modes. Further, it should be noted that the concepts and approaches herein, need not be used in conjunction with any other of the concepts or approaches described herein.

As the UE moves from one geographic location to another, cells with attributes better suited to the UE can become available. Hence, searching for and selecting appropriate cells to obtain service from a plurality of eNBs that can be available to a UE, can significantly enhance quality of communications as this ensures that the UE selects a cell that will provide a most reliable service from amongst the available cells. As the UE encounters various radio environments, it can alternate between different modes primarily comprising an idle mode (where the UE does not actively transfer/exchange packet data) or a connected mode (where the UE is actively transferring packet data). Within a given mode, the UE can be associated with different states based on the serving cell quality as further detailed below. If the quality of the serving cell is not adequate or optimal, then there are various rules that govern how the UE should search for and move to another cell that will provide service if better quality. Optimizing the rules that govern the UE behavior based on the serving cell quality enhances the reliability of communications services. Various aspects described herein are related to the cell reselection and associated measurement behavior in the “camped on any cell state”. These aspects minimize the situation that users are limited with the service provided by the network operator. The proposed schemes help the UE to find a suitable cell while in the ‘camped on any cell’ state, in order that it may obtain high quality communication services.

While, for purposes of simplicity of explanation, the one or more methodologies shown herein, e.g., in the form of a flow chart, are shown and described as a series of acts, it is to be understood and appreciated that the present invention is not limited by the order of acts, as some acts can, in accordance with the present invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

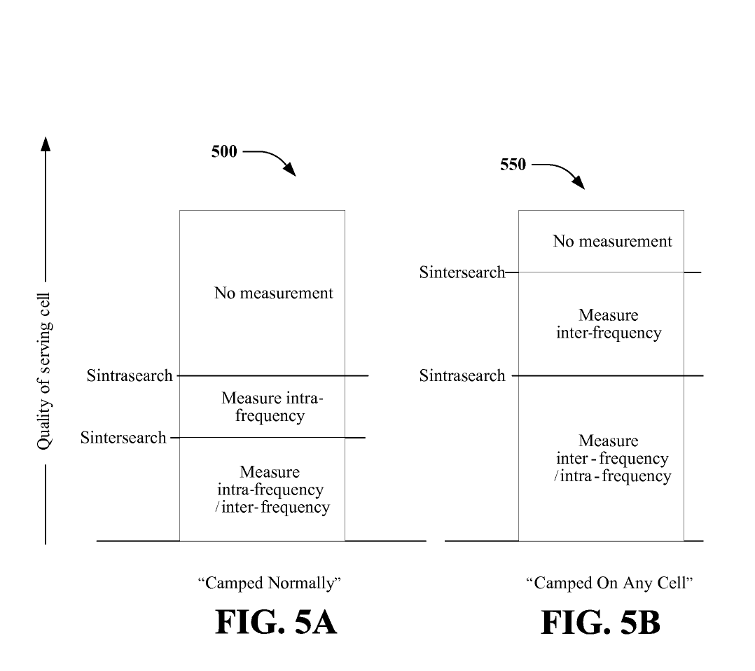

FIG. 4 is a flow chart 400 that details a methodology of cell search in accordance with an aspect. In response to a user request (manual mode) or periodically (automatic mode) the UE begins to search all PLMNs (Public Land Mobile Networks) that are available. Accordingly, at 402 it receives basic details about the network from information which is broadcast by the cells it sees. This information can comprise details regarding the channels that may be used on the cell, how measurements are to be made when using the cells or other system information that is broadcast to all UEs via, for example, BCCH (Broadcast Control Channel) transmissions. In a further aspect, the system information can be stored in a memory associated with the UE. At 404, based on the system information, the cells are evaluated to identify a most suitable cell satisfying the S-criterion (selection criterion) and provided it is not barred or reserved or it does not belong to a forbidden tracking/location area. This can be deduced by the UE, by reading a MIB (master information block) one each cell to identify the PLMN associated with the cell in accordance with an aspect. Accordingly, as shown at 406 it is determined if the suitable cell is found. If suitable cell is identified, the UE camps on it as shown at 408. This state of the UE can be termed as ‘camped normally’ state wherein the UE is camped on a cell of the registered PLMN and can make and receive calls as soon as the location registration process is complete. This permits the UE to monitor the received level and the system information, and check whether cell reselection is needed. Thus, measurements for cell reselection is optional for a UE in a ‘camped normally’ state if the current cell satisfies all the requirements for providing reliable communication services to the UE. If at 406, a suitable cell cannot be identified, the UE tries to locate any available cell as shown at 410. If a cell is available, the UE camps on it in a ‘camped on any cell’ state as shown at 412. This can be a limited service state, for example, wherein the UE is permitted only emergency calls. Upon entering this state, the UE can continue to search for a best cell (cell reselection) and hence the procedure returns to step 402 from step 412. Similarly, if no cell is available for a UE to camp on, the UE continues to search for a best cell by returning to 402 from 410.

Thus, as seen from the aforementioned details of cell selection/reselection procedure, the UE behavior is based on quality of the serving cell. Generally, the UE behavior is governed by measurement rules, which can be predefined threshold criteria based on which the UE can launch cell selection/reselection procedures. The current WCDMA specification (3GPP technical specification—TS25.304) defines the Measurement Rules to minimize the measurement by the UE. Essentially the UE is allowed to omit the measurement if the quality of the serving cell fulfils particular criteria, a similar mechanism is also in place for LTE.

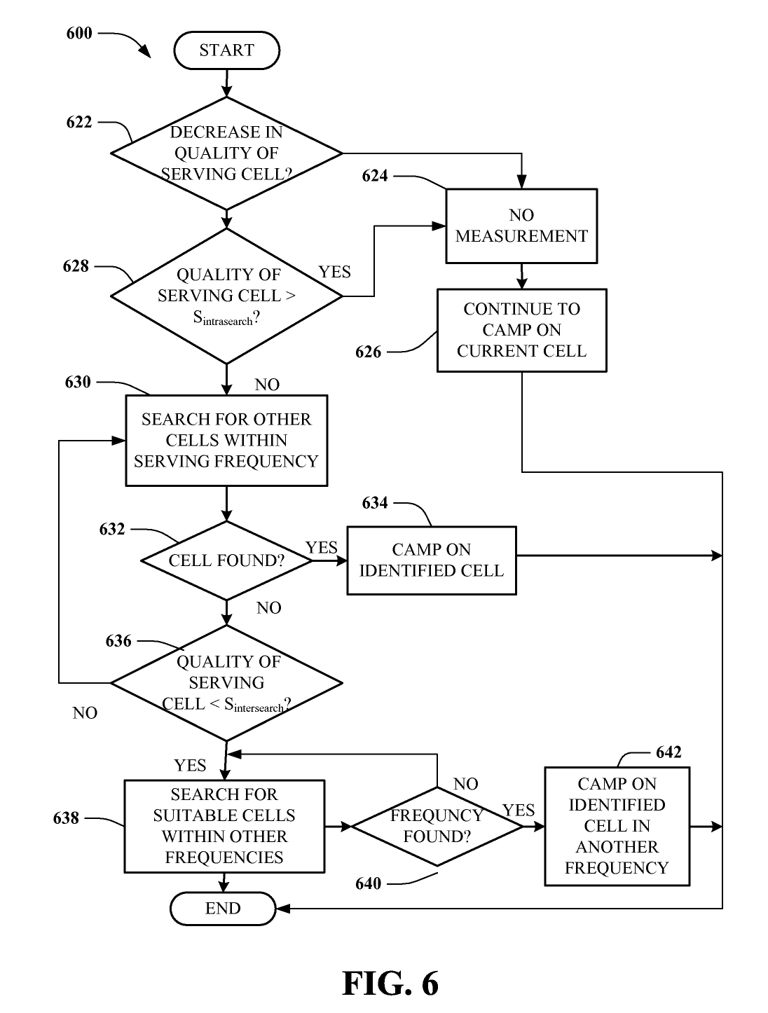

FIG. 5A is a graphical depiction 500 of the measurement rules for the UE in accordance with an aspect when the UE is in a camped normally state. As seen from the FIG. 1f the quality of the serving cell is above a specific predefined threshold S_{intrasearch} then it indicates that the current cell is the best cell (wherein S can be a selection criterion based on received signal quality measured in dB (decibels)). Therefore, the measurement rules prevent the UE from launching further search and hence no measurement takes place. This situation may occur if the UE is ideally positioned at the center of a cell. If the UE is mobile, it may move away from the center of the cell, and as a result the quality of the serving cell may fall. If it goes below S_{intrasearch} the UE starts an intra-frequency search wherein the UE searches for other candidate cells within the same frequency as the currently serving cell. This may occur as the UE nears the edge of the cell. If the quality of the serving cell goes below S_{intersearch} then the UE searches both intra-frequency and inter-frequency cells. The UE is far away from the base station and therefore does carries out different measurements of serving and non-serving frequencies and cells to identify a best candidate cell.

In accordance with current LTE specifications (3GPP technical specification—TS36.304), common measurement rules are used for both “camped normally” and “camped on any cell” states. In general, it may be noted that the UE camping on an acceptable cell has higher probability of finding a more suitable cell in a different frequency or a RAT. However, normally the measurement rules prioritize the measurement of the intra-frequency over the inter-frequency and inter-RAT. Hence, separate measurement rules that prioritize inter-frequency measurements over the intra-frequency measurements for the ‘camped on any cell’ state will encourage the UE to initiate search procedures to move away from the current non-serving cell/frequency. These alternative measurement rules can be based either on the separate set of S_{intrasearch}, S_{intersearch} and S_{searchRAT} parameters, or on a special pre-defined rules (e.g. always search, ignoring the S . . . search parameters). Hence, having different measurement rules based on the state of UE camping institutes a framework for the cell reselection and associated measurement behavior in the “camped on any cell state” which facilitates an operator to minimize as much as possible the situation that their customers are limited with the service provided.

As detailed supra, if a radio best cell is not identified upon an initial search, the UE camps on any available cell wherein it is provided with limited service in a ‘camped on any cell’ state. The UE can continue to search for a cell that will provide better quality by initiating cell reselection procedures that allow the UE to select a more suitable cell and camp on it. When the UE is in either Camped Normally state or Camped on Any Cell state on a FDD cell, the UE can attempt to detect, synchronize, and monitor intra-frequency, inter-frequency and inter-RAT cells indicated by the serving cell. FIG. 5B is a graphical depiction 550 of the measurement rules for the UE in accordance with an aspect when the UE is in a ‘camped on any cell’ state. As seen from the FIG. 1f the quality of the serving cell is above the predefined thresholds S_{intresearch} and S_{intrasearch}, then the UE can assume that the current frequency is the best frequency and the current cell is the best cell for the current frequency even though the UE may be camped on it in a ‘camped on any cell’ state. If the UE is mobile, the quality of the serving cell may fall and if it goes below S_{intersearch}, the UE starts an inter-frequency search wherein the UE searches for other frequencies than the serving frequency and associated candidate cells within those frequencies. Upon comparison with the thresholds defined in the ‘camped normally’ state, it may be noticed that the thresholds for ‘camped on any cell’ state are higher. This facilitates the UE to initiate measurement procedures for cell reselection to find a cell that provides better service. If the quality of the serving cell goes below a first threshold—S_{intersearch} then the UE searches both intra-frequency and inter-frequency. As UE may be receiving limited or no service, it therefore carries out different measurements of serving and non-serving frequencies to identify a frequency and associated candidate cell that will best serve its requirements. If the quality of the current cell is even below the lower threshold—S_{intrasearch}, the UE attempts to detect, synchronize, and monitor intra-frequency, inter-frequency cells indicated by the serving cell. Additionally the threshold S_{intrasearch} can be used by the UE to start an inter-RAT search wherein the UE searches for other RAT than the serving RAT and associated candidate cells within those RATs.

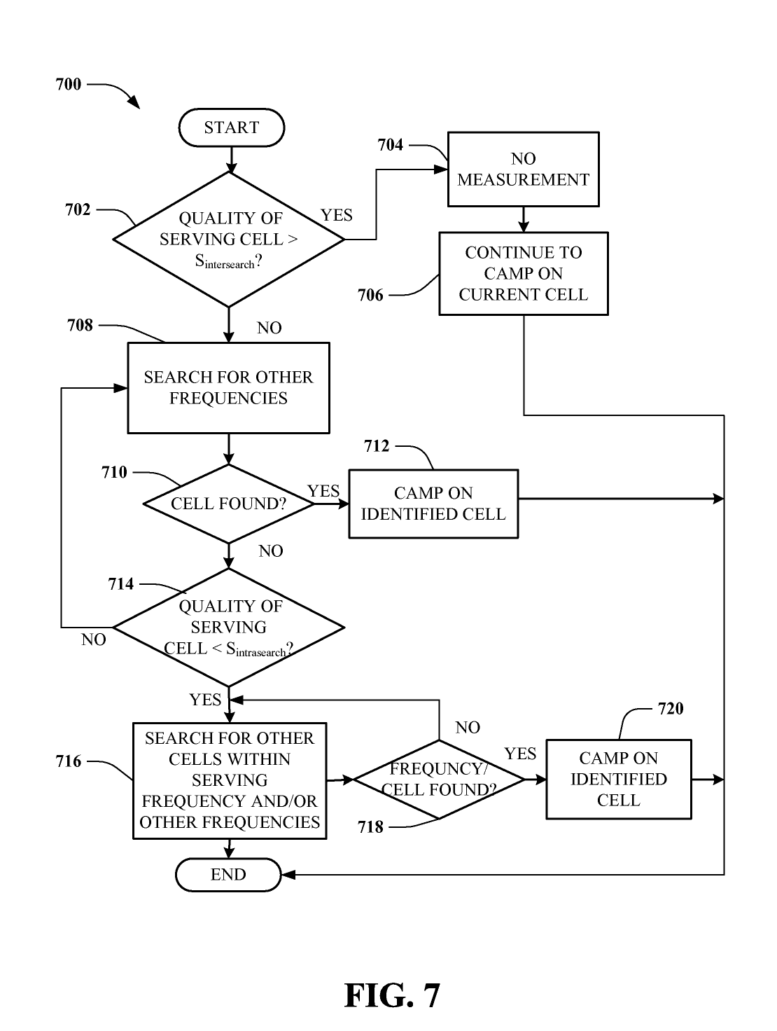

FIG. 6 is a flow chart 600 detailing the procedure of cell reselection in accordance with the measurement rules described herein when the UE is camped normally on a cell. The procedure begins at 622 wherein it is determined if there is any decrease in the quality of a currently serving cell. If the quality of the current cell is steadily maintained above the predefined thresholds, no measurement takes place as shown at 624 and the UE continues to camp on the same cell as shown at 626. In accordance with certain aspects, the UE can continue reselection procedure despite a steady maintenance in quality of a current cell to find a better cell. If it is determined at 622 that there is a decrease in the quality of the cell currently serving the UE, at 628, it is again determined if the quality of the current cell is greater than S_{intrasearch}. If yes, then no measurement takes place as shown at 624 and the UE stays with the current cell as depicted at 626. If it is determined at 628 that the quality of the current cell is below S_{intrasearch}, the UE starts evaluating if there are other cells within the current frequency that can provide better service as shown at 630. If a better cell is identified at 632, the UE camps on the identified cell as shown at 634. If another cell within the current frequency is not identified at 632, the method proceeds to 636 wherein it is determined if the quality of the current cell within the current frequency has deteriorated beyond S_{intersearch}. If yes, the method proceeds to 638 wherein other frequencies are measured to identify a cell that can provide service of a better quality. If it is determined at 636 that the quality of the current cell has not deteriorated below S_{interfrequency}, the method returns to 630 wherein the UE continues to measure other cells within the same frequency. Upon measuring other frequencies and cells associated with other frequencies as shown at 638, it is determined at 640 if another frequency and associated cell is found that can serve the UE better than the current cell. If yes, the UE camps normally on the identified cell as shown at 642. If another frequency/cell is not identified at 640, the UE continues measurement as shown at 638 until the frequency/cell is identified.

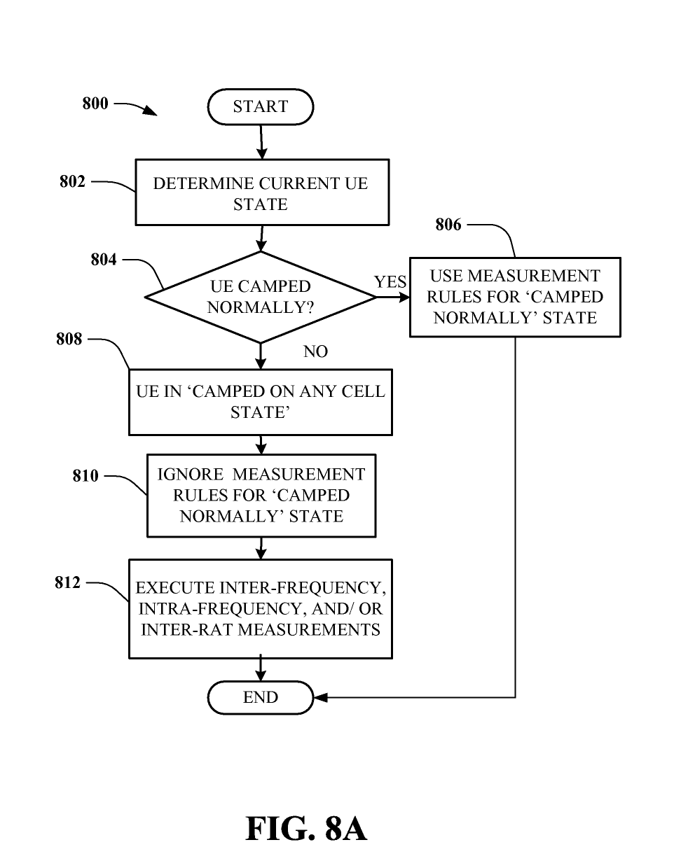

FIG. 7 is a flow chart 700 that illustrates a method of cell searching in accordance with measurement rules when the UE is in a ‘camped on any cell’ mode. Initially at 702, it is determined if the quality of the current cell is above S_{intersearch}. If yes, then it is concluded that there are no cells/frequencies that can serve the UE better than the current cell/frequency. Hence, no measurement takes place as shown at 704 and the UE continues to camp on the current cell as shown at 706. If at 702, it is determined that the quality of the cell is less than S_{intersearch}, the UE searches other frequencies, and cells to identify a frequency and/or cell that will provide better service as shown at 708. At 710, if the cell is found that can serve the UE better, the UE camps on it as shown at 712. Based on the attributes of the cell, the UE can camp on it either in a ‘camped normally’ mode or a ‘camped on any cell’ mode. If no cell is identified at 710, it is once again determined if the quality of the current cell is below another predefined threshold S_{intrasearch} as shown at 714. If the quality of the current cell is above S_{intrasearch} the UE continues to measure other frequencies and cells as shown at 708, else, the UE measures other cells within the same frequency as shown at 716. If another cell is found within the same frequency as shown at 718 that can serve the UE better, the UE camps on it as shown at 720. Based on the attributes of the cell, the UE can camp on it either in a ‘camped normally’ mode or a ‘camped on any cell’ mode. If no cell is identified at 718 the method returns to 716 wherein the UE executes intra-frequency measurements as it attempts to leave the current non-serving frequency.

In this procedure, the interfrequency measurements are prioritized over intrafrequency measurements. Although the method details only inter-frequency measurements, it can be appreciated that one or more of inter-frequency or inter-RAT measurements are prioritized over intra-frequency measurements in accordance with different aspects. Thus, a UE camped on a cell in “camped on any cell” mode and receiving limited or no service is encouraged to search for not only other cells within the current frequency but also other frequencies. This procedure will aid it in identifying a frequency/cell that may provide better service than the currently serving frequency/cell. For example, if the UE is camped on a cell belonging to a forbidden tracking area and the serving cell is the best cell in the serving frequency, then the UE cannot reselect to another cell on the same frequency even if the cell belongs to a tracking area allowed for the UE. Instead, searching for other frequencies may help the UE to find a suitable cell.

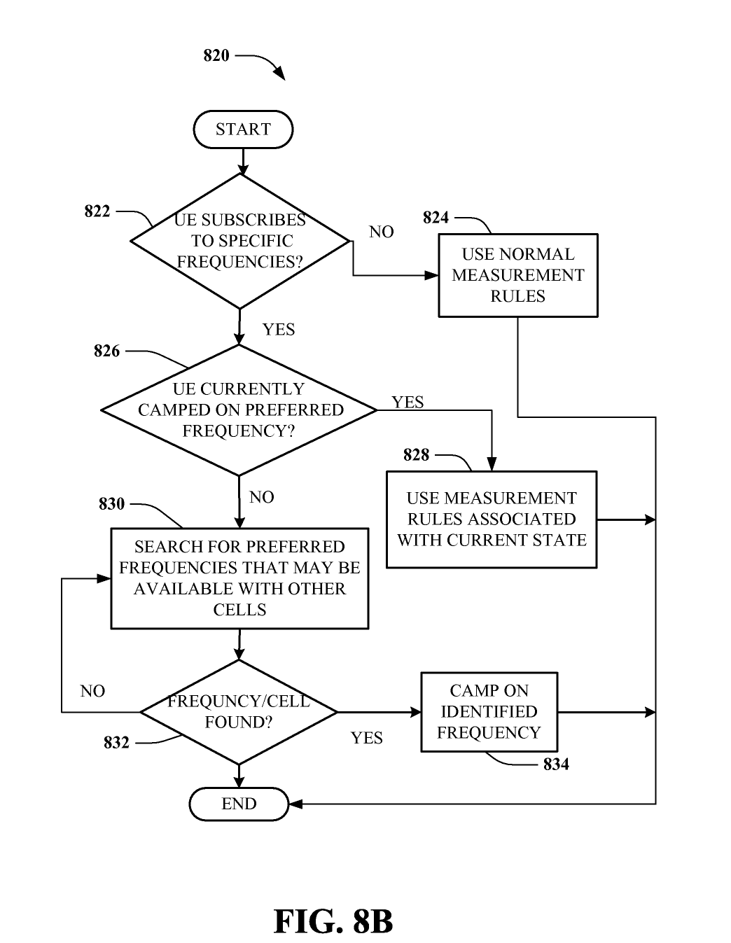

FIG. 8A shows a flow chart 800 that details another aspect related to adapting/ignoring measurement rules depending on the attributes a the UE and/or serving frequencies. Based on the attributes of the UE, the measurement rules can be either customized as described supra or they can even be ignored as further detailed in this method. The method begins at 802 wherein current state of the UE is determined. If the UE is currently camped normally as shown at 804 then measurement rules applicable to that state are utilized to carry out UE measurements as shown at 806. If however, it is determined that the UE is not camped normally, then it is determined that UE is in a ‘camped on any cell’ state wherein it may be receiving limited or no service as shown at 808. Accordingly, the UE can opt to ignore measurement rules normally governing its behavior in this state as shown at 810 and instead execute all kinds of inter-frequency, inter-RAT and/or intra-frequency measurements as detailed herein as seen at 812 in order to leave the current cell and camp on another cell that will provide it with better service. Thus, based on the UE attributes such as its state, different measurement rules can be adopted or the measurement rules can be ignored completely.

FIG. 8B is a flow chart 820 related to another aspect wherein based on the attributes of the frequencies and the subscription plan associated with the UE different measurement rules can be adopted for the cell selection/reselection procedures. The procedure begins 822 wherein it is determined if the UE subscribes to specific frequencies. For example, the subscription plan associated with the UE can be a premium plan that entitles the UE to certain preferred frequencies not available to general plan subscribers. If at 822, it is determined that the UE is associated with the normal plan then the UE continues to use measurement rules generally associated with it such as those based on its camping state as shown at 824. If it is determined at 822 that the UE is associated with a premium plan that provides it access to certain reserved frequencies that can provide it with better quality service, at 826 it is determined if the UE is currently camped on the reserved frequencies. If yes, then the UE adopts normal measurement rules associated with its current status as shown at 824 and eventually the method reaches the end block. If at 826 it is determined that the UE is not camped on the preferred/reserved frequencies, the UE adopts measurement rules that aid/encourage it to launch a search for the preferred frequencies as shown at 828. At 830 a search is initiated for the preferred frequencies within the current cell and/or other cells that will provide service on the preferred frequencies. If an appropriate frequency/cell is located at step 832, then the UE camps on that frequency/cell as shown at 834, else, the method returns to 830 to continue the search for the preferred frequencies and/or cells offering service on the preferred frequencies.

In accordance with the various selection/reselection procedures detailed above, the UE generally attempts to locate a cell that provides a best radio quality within a given frequency to camp on. If the UE is in a cell that is not the best cell for the currently utilized frequency, it may produce interference to other cells on that frequency. Hence, the UEs within a communication system always camp on a radio best cell for a given frequency. Accordingly, during the cell selection/reselection procedures, the UEs institute a ranking process wherein the UEs measure all the available cells on a given frequency, rank them by their radio quality and camp on a cell with the best radio quality. However, UEs generally do not take into account the access restrictions on the cells during the ranking process. For example, while ranking the cells on a given frequency, the UE does not consider PLMN id or LAC/RAC (Location Area Code/Routing Area Code) of the cells. Accordingly, the cells belonging to registered and non-registered PLMN IDs or forbidden location/tracking areas are all treated equally in the ranking process. Hence, while taking into account only the radio quality of the cells a UE can finally camp on a cell within a non-registered PLMN ID or a forbidden tracking area (TA).

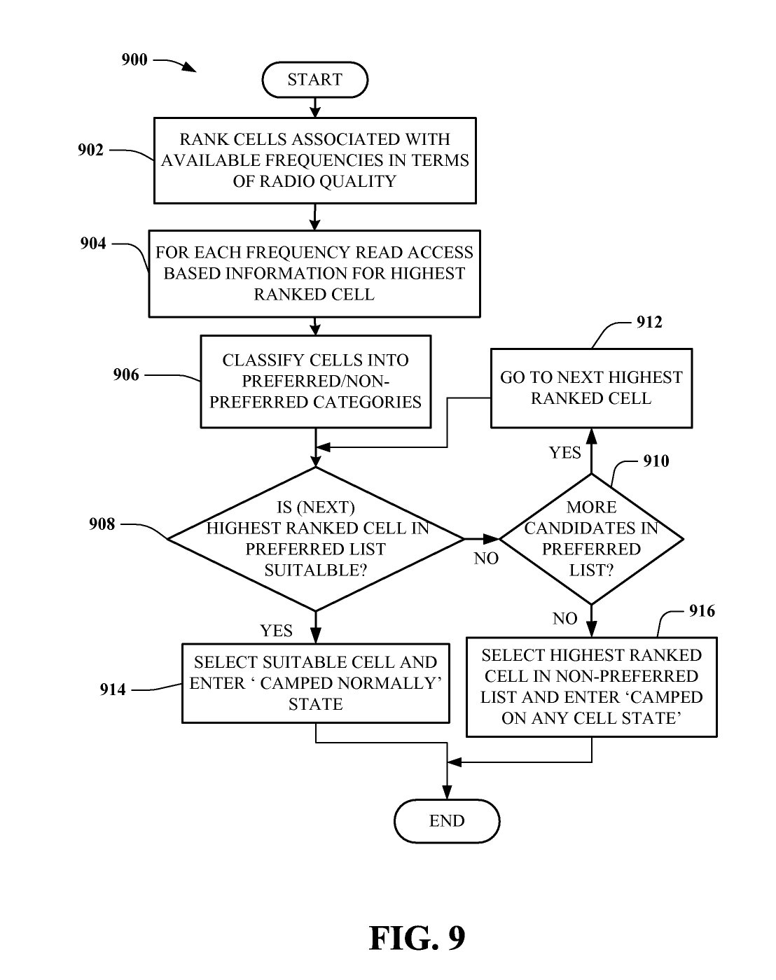

FIG. 9 is a flow chart 900 detailing a more efficient ranking mechanism in accordance with an aspect wherein the UE reads the access restriction related information from the highest ranked cell for each frequency as part of measurement process or at the beginning of the ranking process. Accordingly, at the main ranking process, the UE can use the information to take a hard comparison to select a desirable frequency layer, rather than a soft comparison based only on radio quality. The method begins at 902 with a ranking process wherein cells associated within PLMNs of the network are initially ranked for each available frequency based on their radio quality. At 904, for each frequency, the access based information such as access restrictions are read for the highest ranked cell associated with the frequency. Based on the access restriction information and/or other access restriction information provided to the UE separately, the cells are categorized as either preferred or non-preferred as shown at 906. As mentioned supra, if the cell is associated with a non-registered PLMN id or a forbidden location/tracking area it can be classed as non-preferred while other cells not associated with such restricted attributes can be classified as preferred cells in accordance with an aspect. At 908, the cells in the preferred list are evaluated to determine if they are appropriate/suitable candidates for a cell reselection wherein the UE will be able to camp normally. If a cell being examined is a suitable cell, then the UE camps normally on the cell as shown at 914 else it is determined at 910 if there are more candidates on the preferred candidate cell list. If yes, the procedure moves to 912 wherein the next highest ranked cell is selected to examine its suitability else it can be concluded that none of the cells on the preferred list are suitable for the UE to camp normally. Accordingly, at 916, a highest ranked cell in the non-preferred list is selected and the UE camps on it in a “camped on any cell” mode.

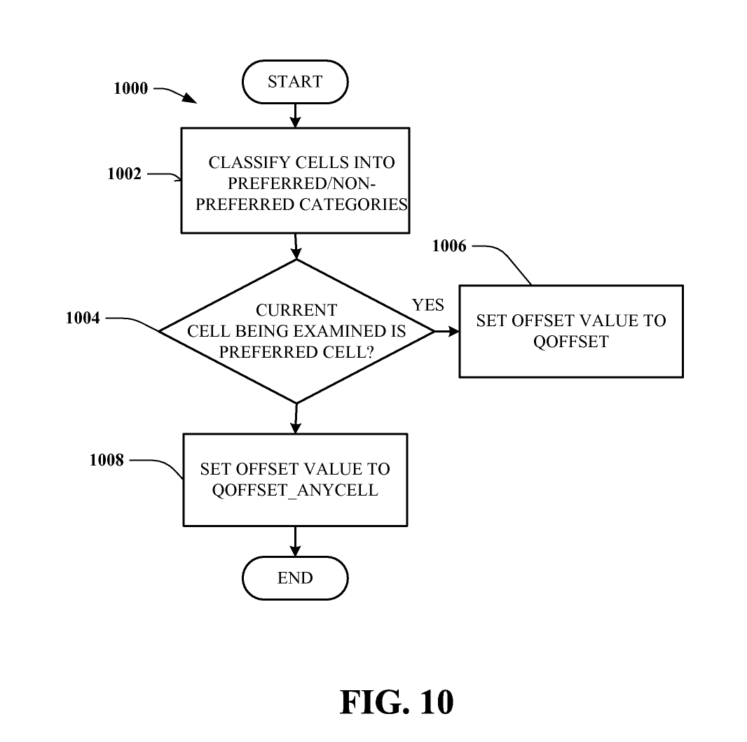

FIG. 10 depicts a simple flow chart 1000 that details the categorization of cells in accordance with an aspect. The method begins at 1002 with the UE classifying the cells into preferred and non-preferred categories based at least on their access related attributes. At 1004 it is determined if a cell being examined is a preferred cell. If yes, the procedure sets the cell with a normal Qoffset (Quality offset) as shown at 1006 indicating that the cell is available for camping normally else another offset Qoffset_anycell is set as shown at 1008 indicating that the cell is non-preferred as the UE can only camp on it in a “camp on any cell” state. The Qoffset parameters are used to apply the offset to the measured radio quality of corresponding cells. In particular the Qoffset_anycell parameter is used in the ranking process to make inter-frequency or inter-RAT cells appear to provide better services so that the UE is encouraged to move from the serving frequency. The Qoffset_anycell can be either hard-coded in the specification or signaled to the UE over the air.

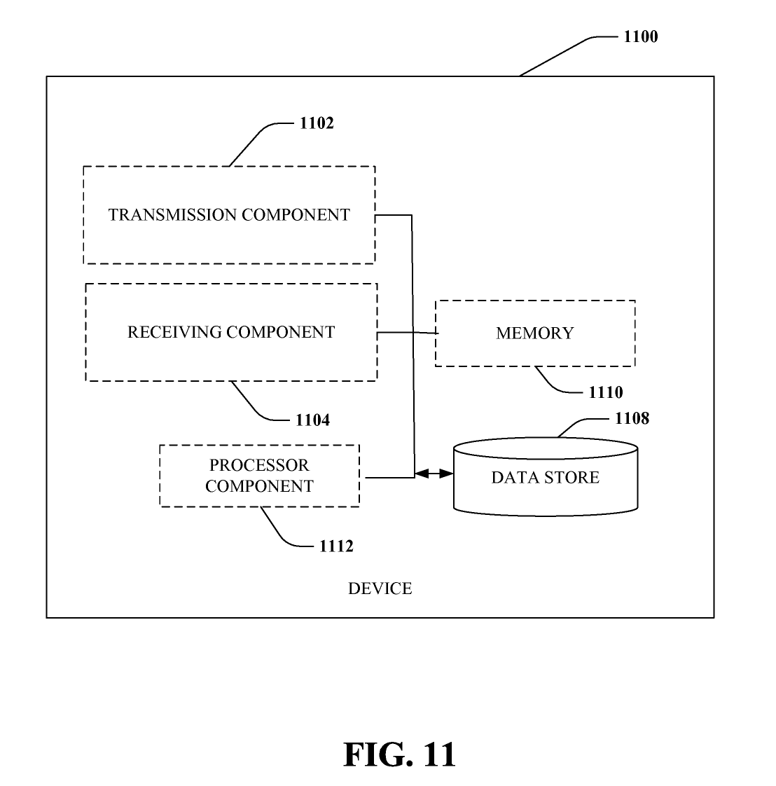

FIG. 11 is a high level diagram illustrating various components of a device 1100 in accordance with different aspects described herein. The device 1100 can be an eNode B, an UE or a combination thereof. The device comprises a transmission component 1102 for transmitting various communications. If the device is acting as an UE then the transmission component 1102 can transmit various communications on the uplink to a serving eNode B/base station. The communications can include resource requests, data transmission on assigned resources etc. The device also comprises a receiving component 1104 for receiving communications from various entities including eNode B, other UEs etc. Upon transmission of resource requests, the receiving component can receive control messages relating to assignment of resources for uplink communications or data transmissions. In accordance with an aspect, the receiving component 1104 can receive, for example, control messages related to handover procedures, system information to assess suitability of a cell to camp on, other information such as assignment of resources within a selected cell associated with a eNB. Although transmission/receiving components are shown in this figure as two separate components, it can be appreciated that this is not necessary and that their functionality can be combined into a single communication component. These messages can be stored in the data store 1106. Data store 1106 can be any suitable combination of hardware and/or software that provides for mass storage of information, databases, and programs employed in connection with aspects described herein. The device 1100 may optionally comprise a volatile/non-volatile memory 1110 including random access memory (RAM), read only memory (ROM), or a combination thereof. These messages are decoded and processed by a processing component 1112. In accordance with an aspect, the control messages received from a serving base station/eNode B can be decoded and processed in order to identify the assignment information associated with resources. As detailed supra, these messages can deliver network information in the form of system information blocks (SIBs). This information can be decoded and stored in the memory 1110 and/or data store 1106 in order to aid the UE in selecting an appropriate cell to camp on. Based on the stored information, the processing component 1112 can also determine offset values that aid it in setting preferences associated with different eNode Bs in the neighborhood. This helps the UE to select an appropriate cell to camp on thereby ensuring best services that the UE can receive based on different attributes of the existing network.

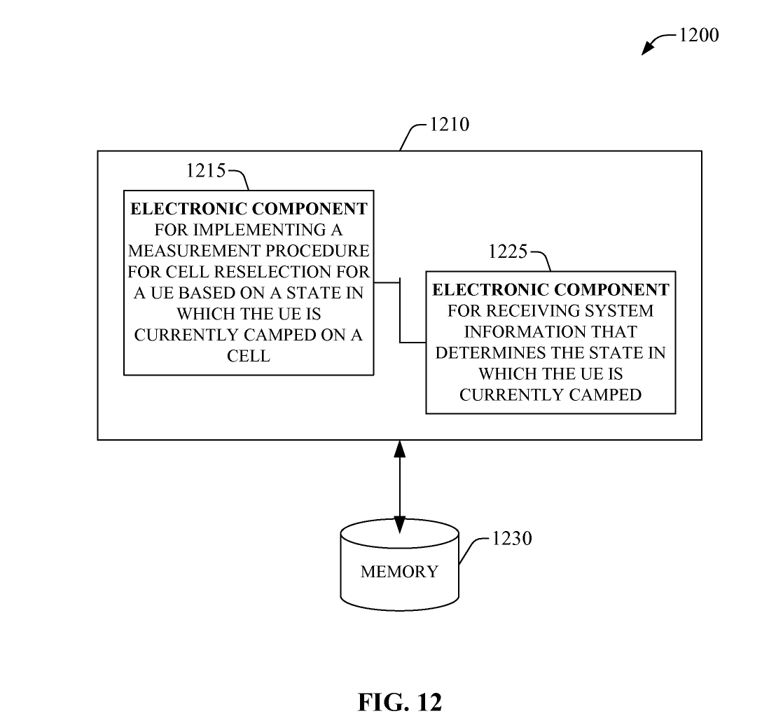

Next, a system that can enable aspects of the disclosed subject matter are described in connection with FIG. 12. Such systems can include functional blocks, which can be functional blocks that represent functions implemented by a processor or an electronic machine, software, or combination thereof (e.g., firmware).

FIG. 12 illustrates a block diagram of an example system 1200 that enables cell selection. System 1200 can reside at least partially within a mobile, for example. System 1200 includes a logical grouping 1210 of electronic components that can act in conjunction. In an aspect, logical grouping 1210 includes an electronic component 1215 for implementing a measurement procedure for cell reselection for a UE based on a state in which the UE is currently camped on a cell; and an electronic component 1225 for receiving system information that determines the state in which the UE is currently camped.

System 1200 can also include a memory 1230 that retains instructions for executing functions associated with electrical components 1215 and 1225, as well as measured or computed data that may be generated during executing such functions. While shown as being external to memory 1230, it is to be understood that one or more of electronic components 1215 and 1225 can exist within memory 1230.

The data transmission techniques described herein may be implemented by various means. For example, these techniques may be implemented in hardware, firmware, software, or a combination thereof. For a hardware implementation, the processing units used for data transmission at a transmitter or data reception at a receiver may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the techniques may be implemented with modules (e.g., procedures, functions, and so on) that perform the functions described herein. The firmware and/or software codes may be stored in a memory and executed by a processor. The memory may be implemented within the processor or external to the processor.

The previous description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A method for providing service within a wireless communication system, comprising:
determining a state in which a UE is camped on a cell; and
facilitating the UE to carry out one or more measurements for cell reselection based at least on the state of camping on the cell.

2. The method of claim 1, wherein the UE is camped on the cell in a camped on any cell state which causes the UE to receive limited or no service.

3. The method of claim 2, further comprising prioritizing one or more of inter-frequency or inter-RAT (Radio Access Technology) measurements over one or more intra-frequency measurements.

4. The method of claim 3, further comprising camping normally on a most suitable cell identified in at least one of the inter-frequency or inter-RAT measurements.

5. The method of claim 3, further comprising executing the intra-frequency measurements if no cell is identified in at least one of inter-frequency or inter-RAT measurement.

6. The method of claim 2, wherein the UE subscribes to one or more preferred frequencies and is camped on a non-preferred frequency.

7. The method of claim 6, further comprising executing the inter-frequency measurements that identify if one or more of the preferred frequencies is available to the UE.

8. The method of claim 7, further comprising camping on at least one of the one or more preferred frequencies that are available to the UE.

9. The method of claim 1, further comprising reading access related information of one or more other cells during the measurements for the cell reselection.

10. The method of claim 9, wherein the measurements relate to inter-frequency measurements and the access related information is associated with a highest ranked cell for each frequency.

11. The method of claim 9, further comprising classifying the one or more other cells into preferred and non-preferred categories based on the access related information.

12. The method of claim 11, further comprising applying a radio quality offset value with one or more cells in the non-preferred category in the cell ranking process such that the UE is encouraged to move to at least a cell indentified in one or more of inter-frequency or inter-RAT search.

13. The method of claim 1, further comprising facilitating the UE indentifying an alternate cell using a cell reselection parameter when the UE is camped on a barred cell in a ‘camped on any cell’ state.

14. An apparatus for facilitating cell selection within a communication system, the apparatus comprising:
a processor that implements a measurement procedure for cell reselection for a UE based at least on a state in which the UE is currently camped on a cell; and
a memory component that stores received system information that determines the state in which the UE is currently camped.

15. The apparatus of claim 14, wherein the state is a camped on any cell state and the measurement procedure prioritizes one or more of inter-frequency or inter-RAT searches over an intra-frequency search.

16. The apparatus of claim 14, the processor facilitates easier communication on one or more preferred frequencies when compared to other one or more non-preferred frequencies.

17. The apparatus of claim 16, wherein the UE is camped on one of the non-preferred frequencies in a camped on any cell state.

18. The apparatus of claim 17, the measurement procedure executes one or more inter-frequency measurements that identify if at least one of the preferred frequencies is available for the UE to camp in a camped normally state.

19. The apparatus of claim 14, further comprising a receiving component that receives the system information comprising one or more access restrictions associated with at least a cell.

20. The apparatus of claim 19, the processor reads and analyzes the access restrictions for ranking a plurality of cells during the measurement procedures for the UE to camp on.

21. The apparatus of claim 20, further comprising one or more offset values stored in the memory component that are associated with one or more cells that only permit the UE to camp in a camped on any cell state.

22. The apparatus of claim 21, the offset values are used in the ranking process to make inter-frequency or inter-RAT cells look better so that the UE is encouraged to move from the serving frequency.

23. A computer program product, comprising:
a computer-readable medium comprising:
code for causing at least a computer to determine a state in which a UE is camped on a cell; and
code for causing at least a computer to facilitate the UE to carry out one or more measurements for cell reselection based at least on the state of camping on the cell.

24. The computer program product of claim 23, wherein the UE is camped on the cell in a camped on any cell state which causes the UE to receive limited or no service.

25. The computer program product of claim 24, the computer-readable medium further comprising code for causing at least a computer to prioritize one or more of inter-frequency or inter-RAT (Radio Access Technology) measurements over one or more intra-frequency measurements.

26. The computer program product of claim 25, the computer-readable medium further comprising code for causing at least a computer to camp normally on a most suitable cell identified in at least one of the inter-frequency or inter-RAT measurements.

27. The computer program product of claim 25, the computer-readable medium further comprising code for causing at least a computer to execute the intra-frequency measurements if no cell is identified in at least one of inter-frequency or inter-RAT measurement.

28. The computer program product of claim 24, wherein the UE subscribes to one or more preferred frequencies and is camped on a non-preferred frequency.

29. The computer program product of claim 27, the computer-readable medium further comprising code for causing at least a computer to execute the inter-frequency measurements that identify if one or more of the preferred frequencies is available to the UE.

30. The computer program product of claim 29, the computer-readable medium further comprising code for causing at least a computer to camp on at least one of the one or more preferred frequencies that are available to the UE.

31. The computer program product of claim 23, the computer-readable medium further comprising code for causing at least a computer to read access related information of one or more other cells during the measurements for the cell reselection.

32. The computer program product of claim 31, wherein the measurements relate to inter-frequency measurements and the access related information is associated with a highest ranked cell for each frequency.

33. The computer program product of claim 31, the computer-readable medium further comprising code for causing at least a computer to classify the one or more other cells into preferred and non-preferred categories based on the access related information.

34. The computer program product of claim 33, the computer-readable medium further comprising code for causing at least a computer to apply a radio quality offset value with one or more cells in the non-preferred category such that the UE is encouraged to move to at least a cell indentified in one or more of inter-frequency or inter-RAT search.

35. The computer program product of claim 23, the computer-readable medium further comprising code for causing at least a computer to facilitate the UE to identify an alternate cell using a cell reselection parameter when the UE is camped on a barred cell in a ‘camped on any cell’ state.

36. A system for facilitating cell selection, the system comprising:
means for implementing a measurement procedure for cell reselection for a UE based on a state in which the UE is currently camped on a cell; and
means for receiving system information that determines the state in which the UE is currently camped.

37. The system of claim 36, wherein the state is a camped on any cell state and the measurement procedure prioritizes one or more of inter-frequency or inter-RAT searches over an intra-frequency search.

38. The system of claim 36, the implementing means prioritizes the UE on one or more preferred frequencies when compared to other one or more non-preferred frequencies.

39. The system of claim 38, the measurement procedure executes one or more inter-frequency measurements that identify if at least one of the preferred frequencies is available for the UE to camp in a camped normally state when the UE is camped on one of the non-preferred frequencies in a camped on any cell state.

40. The system of claim 36, further comprising means for receiving that receives the system information comprising one or more access restrictions associated with at least a cell for ranking a plurality of cells during the measurement procedures for the UE to camp on.
